(19) United States
(12) Patent Application Publication
(10) Pub. No.: US 2021/0254387 A1
(43) Pub. Date: Aug. 19, 2021

(54) DOOR DEVICE HAVING MOVABLE SENSOR COMPONENT FOR ENVIRONMENT DETECTION AND METHOD FOR ENVIRONMENT DETECTION AT A DOOR DEVICE

(71) Applicant: INVENTUS ENGINEERING GMBH, ST. ANTON I.M. (AT)

(72) Inventor: STEFAN BATTLOGG, ST. ANTON I.M. (AT)

(21) Appl. No.: 17/252,115

(22) PCT Filed: Feb. 11, 2019
(86) PCT No.: PCT/EP2019/053240

§ 371 Date: Dec. 14, 2020

(30) Foreign Application Priority Data
Feb. 13, 2018 (DE) 10 2018 103 115.7

(51) Int. Cl. E05F 15/42; B60J 5/04; E05F 15/619

(52) U.S. Cl. CPC E05F 15/42; B60J 5/04; E05F 15/619; E05Y 2400/54; E05Y 2201/716; E05Y 2201/722; E05Y 2900/531; E05Y 2201/434

(57) ABSTRACT

A rear door device of a motor vehicle has a door structure that can be moved relative to a base frame. For environment detection, a sensor component that can be moved out is at least partially held on the door structure or the base frame. There is also described a near-field detection method for preventing damage to the vehicle from ambient structures.

The present invention relates to a door device and in particular to a door device of a motor vehicle and to a method. In particular, the invention relates to such a door device of a motor vehicle, which can be opened passively, actively or semi-actively. This means that a braking device or/and a door drive is arranged on or in the door device of the motor vehicle or that such a door drive/door brake is associated with the door device in order to brake the actual door or to be able to open and/or close it actively.

When passively, actively or semi-actively opening or closing doors of motor vehicles, special care must be taken to ensure that the door is not damaged during the opening and/or closing movement. For example, interfering bodies or foreign objects may be present on the door's path of movement and damage the door if it is opened or closed without care. For example, there may be posts or walls or boundary stones or pillars of an underground parking garage that may dent, scratch, and/or damage the surface of the door. In addition, a user may pinch the fingers of a hand, for example, when opening or closing the door. Therefore, for passive, but in particular for active or semi-active doors of a motor vehicle, it is of considerable advantage if a sensor detects the environment of the motor vehicle so that it is possible for the control system to intervene in an opening or closing movement of a door of a motor vehicle. For this purpose, sensors require a “clear view” in order to be able to function properly.

Known from the prior art are in particular solutions for the front door. These are sensors which are mounted in the exterior mirror, in or on the vehicle door. Mounting in the exterior mirror only works for the front doors because, e.g., in the case of an open front door, the rear door can no longer be detected by the sensor because the door obscures this area. This also applies to sensors that are mounted in or on the outer skin of the front door. As soon as the door is open, it is no longer possible to also detect the area around the rear door. Rear doors do not have any protruding components, such as mirrors, which detect the area in the same way as front doors and swivel along with them.

Visible sensors mounted in the outer skin of the door, such as those installed, e.g., as parking sensors in many vehicles, are not accepted in the outer skin of the door by car designers and customers because the doors are an important design element in vehicles.

Mounting the sensor in the trim, usually at the bottom of the door, is possible. However, modern cars have hardly any trim, but smooth painted doors. A viewing window for the sensor in the door's outer skin is virtually impossible from a design standpoint if the sensor is mounted inside the door.

If the sensor is placed further inside the door, i.e. behind the door panel (door's outer skin), this restricts the viewing area (measuring cone). In addition, only certain sensor types can see through the door or door panel and/or special door panel materials must be used. These in turn have disadvantages in terms of measurement quality and detection range.

Weather influences, such as snow, ice, dust or dirt, generated by the vehicle itself (dirt/spray generated by the tire, in particular in winter or in case of loose ground) can also severely deteriorate sensor measurement/sensor value quality and make error-free measurement or measurement of the surroundings/near field with measurement errors that are not detrimental to the intended use impossible.

It is therefore the object of the present invention to provide an improved door device and an improved method for opening and/or closing doors which, preferably for the rear door and under various (i.e., also more difficult) everyday conditions, achieve the best possible result for the application. Best possible means that the customer should be able to open and close the vehicle door as often as possible or almost always in a process-reliable manner. If this is not possible, the customer should be informed of this or be able to recognize it.

This object is achieved by a door device with the features of claim 1 and by a method with the features of claim 24. Preferred refinements of the invention are the subject matter of the subclaims. Further advantages and features of the present invention will be apparent from the general description and the description of the exemplary embodiments.

A door device according to the invention is designed in particular as a door device of a motor vehicle and can preferably be provided as a rear door device or door of a motor vehicle. A door device according to the invention comprises a base frame and a door structure that is movable relative thereto. In particular, the door structure is arranged to be pivotable relative to the base frame. For environment detection, at least one at least partially moveable sensor component is at least partially accommodated on or closely adjacent to the base frame and/or the door structure.

The door device according to the invention has many advantages.

In particular, the sensor component supports or enables a near-field detection in the surrounding area of the movable door structure, or an environment detection. Preferably, the sensor component enables detection of foreign objects in the range of a possible door movement of the movable door structure. The at least partially movable sensor component is in particular designed to be extendable. For example, part of the sensor component can be extendable from a housing part or a receptacle of the sensor component.

The term “closely adjacent” means here that the distance is less than ⅕ or less than 1/10 or less than 1/20 of the maximum extent (length, width) of the door structure. Preferably, the distance is less than 30 cm and in particular less than 20 cm and preferably less than 10 cm from the nearest point of the door structure.

The moveable part of the sensor component moves in particular with respect to a sensor receptacle. The sensor receptacle can be arranged on the base frame or on the door structure or on the body of a vehicle.

The base frame of the door device can be understood as a separate frame for holding the movable door structure. As a rule, however, the base frame is to be regarded as the base frame or body of a motor vehicle. However, it is also possible that the base frame is attached to the body of a motor vehicle.

Preferably, the sensor component can be extended from at least one protected position (in particular protected from soiling) into at least one detection position. The protected position is in particular a position protected from soiling.

In a preferred refinement, the sensor component comprises at least one sensor head. Preferably, the sensor head is arranged at least temporarily outside the door structure. In all embodiments, the sensor head may be a portion and in particular an outer portion or end portion of the sensor component.

In advantageous refinements, at least the sensor head of the sensor component is accommodated substantially within the door structure in an idle state. It is possible that the sensor head of the sensor component is substantially always or always accommodated within the door structure.

It is preferred that in a measurement state, at least the sensor head of the sensor component is at least partially arranged outside of the door structure.

Particularly preferably, the sensor head is movable between at least two positions relative to the door structure. In advantageous embodiments, the sensor head is situated at least partially, and in particular substantially completely, within the door structure when the sensor component is in an idle state. Preferably, the sensor head of the sensor component is situated at least partially outside the door structure when the sensor component is in a measurement state.

In all embodiments, it is preferred that the sensor head can be moved out of the interior of the door structure.

In a particularly preferred refinement, the door device is configured as a rear door device of a motor vehicle and preferably a rear door of a motor vehicle having a door structure that is movable relative to a base frame, wherein for the purpose of environment detection, at least one movable sensor component is at least partially accommodated on or closely adjacent to the door structure or the base frame and wherein the sensor component comprises a sensor head, and wherein the sensor component can be extended from a protected position into at least one detection position in which the sensor head is arranged at least partially outside of the door structure or of the base frame. Such an embodiment and the refinements thereof are highly advantageous.

Preferably, in all embodiments and refinements of the invention, a sensor component comprises two opposing sensor heads arranged at least temporarily outside of the door structure.

In all refinements and embodiments it is preferred that the door structure comprises a door body and an outer skin and/or an inner skin. Particularly preferably, attachment parts, such as trim elements and/or seals, are mounted in or on the door body. Particularly preferably, the sensor head can be moved through an attachment part. For example, the sensor head can be moved through a recess in the attachment part or through an opening in the attachment part in order to be moved outwardly from the interior of the door body.

Preferably, at least one actuator, such as an active actuator and/or at least one passive actuator, is comprised. Such an actuator is used to move the sensor head. It is possible that an active actuator is provided for extending the sensor head outwards. Likewise, it is possible that a passive actuator is provided for retracting the sensor head.

It is also possible that the actuator comprises a positive control, such as a sliding-block guide and/or a spring unit. It is possible, for example, that the actuator is extended by means of a spring unit and retracted again by means of a sliding-block guide. If the sensor head is extended by means of a spring unit and returned to its original position by means of a sliding-block guide when the door is closed, an advantageous embodiment is implemented in which no electric drive is required. At the same time, a positive guide, such as a sliding-block guide, ensures that the sensor head is in a suitable position at all times when it is retracted and extended. This prevents shearing or jamming of the sensor head when opening and closing the door. An accordingly adapted electrical control (without the use of a positive guide) is also possible.

Particularly preferred are embodiments in which jamming or shearing off of the sensor head is ruled out by design. This is particularly the case without the sensor head having to move. This provides inherent safety.

In all embodiments, it is preferred that the actuator comprises at least one electric, hydraulic and/or pneumatic motor. Particularly preferably, an electric motor is used. Particularly preferably, the torque that can be applied by the actuator or the force that can be applied is such that injuries of users are reliably avoided.

In all embodiments, it is preferred that the drive and in particular the motor is accommodated in the interior of the door structure and in particular of the door body.

Preferably, at least one portion of the sensor head is formed to be flexible and/or bendable. Particularly preferably, the distal end portion of the sensor component is formed to be flexible and/or bendable. This allows the end portion of the sensor component or sensor head to flexibly deflect when the sensor head abuts against obstacles.

In preferred embodiments, at least one portion of the sensor head extends into a wheel well of a motor vehicle. In the retracted and in the extended state, there is particularly preferably a sufficient distance from a tire of the motor vehicle. In particular, the distance is greater than 2 cm, 3 cm or greater than 5 cm or even greater than 10 cm.

In preferred embodiments, a horizontal detection angle of the sensor component is greater than 90°, 120° and particularly preferably greater than 150°. Embodiments are also possible in which a detection angle of 180° or more is achieved.

A vertical detection angle of the sensor component is in particular >45° and preferably greater than 60° and particularly preferably greater than 75°. A vertical detection angle of 90° or even 120° or more is advantageous. As a result, a large area can be detected, whereby possible damage can be reliably prevented.

It is preferred that the sensor head rotates and/or oscillates or/and wobbles during the measuring process. These movements can only be partial movements so the sensor head does not have to rotate completely by 360°, for example. It may also rotate, oscillate or wobble only by a few degrees. This can mean, e.g., that the sensor head swivels back and forth and/or repeatedly extends and retracts.

It is possible and preferred that the sensor component and/or the sensor head includes at least one image recognition sensor and an image evaluation system processes corresponding information. Here, image recognition is in particular also pattern recognition and image processing. Preferably, objects in an image are segmented. These objects are assigned a symbolic description. In addition, a pattern analysis can be performed. Depending on position information (e.g. GPS) and other data, such as date, time, weather, windshield wiper “on” or “off”, said information is analyzed and weighted differently. For example, in winter and at low temperatures, the focus is mainly snow, whereas in summer, mainly leaves or bushes are analyzed and processed as a result therefrom and passed on to increase the measurement quality and thus the door opening and closing quality. If snow is analyzed, the door can be moved closer to the collision object (snow) or, if necessary, even into the snow, so that exiting is possible at all. This also applies, e.g., when parking next to a shrub/bush.

In all embodiments it is possible that the environment is already measured during the extension movement of the sensor head thereby resulting in a spatial image of the environment. Here, the sensor can also measure the area between the door opening cutout and the door (the entry/exit area). This is of advantage during the closing process to avoid, among other things, pinching of fingers.

In all embodiments it is preferred that the door device comprises at least one braking device in order to be able to specifically brake a relative movement of the door structure with respect to the base frame. Particularly preferably, a door device comprises a door drive for selectively opening and/or closing the door structure. With a door drive and a braking device, it is possible to open and close automatically and to control and hold predefined or sensor-determined angular positions. For example, the door structure of the door device can stop short of a foreign body or interfering body in order to allow the door to open as wide as possible and, on the other hand, to reliably prevent damage.

In advantageous embodiments, the braking device is designed as a magnetorheological braking device. However, it is also possible to use an electrical or magnetic or other braking device.

The method according to the invention is used for near-field detection on a door device and in particular on a door device of a motor vehicle and preferably on a rear door of a motor vehicle, but can also be used on a front door of a motor vehicle. Provided is a door structure that can be moved relative to a base frame. The method is carried out in order to detect in particular harmful foreign/collision bodies in a range of a possible door movement. In the process of this, at least part of the surroundings of the door structure is detected with a movable sensor head of a sensor component during or before opening the door structure.

In preferred embodiments, the method is used for near-field detection of a door device and in particular of a door device of a motor vehicle and preferably of a rear door device of a motor vehicle, wherein a door structure that is movable relative to a base frame is provided, and wherein the method is carried out in order to detect collision objects in a range of a possible door movement (in particular with improved measurement accuracy and lower error frequency), wherein a sensor head of a movable sensor component detects at least part of the surroundings of the door structure during or before opening the door structure and is in particular extended for this purpose.

In another preferred embodiment, a method is used for influencing a door movement process of a rear door device of a motor vehicle with a door structure that is movable relative to a base frame, wherein a movable sensor component detects at least part of the surroundings of the door structure and these measurement data influence the door movement process.

In advantageous embodiments, the sensor head is at least partially extended from the door structure. By extending the sensor head, a larger detection range/measuring cone is made possible. As a result, a larger measuring angle range can be covered and all kinds of collisions/damage to the door device and in particular to the door structure and, for example, the outer skin of the door structure can be avoided.

Preferably, the sensor head is at least partially extended from the door structure prior to a measurement. Particularly preferably, the sensor head is actively extended from the door structure. It is possible and preferred that the sensor head is retracted again in an actively controlled manner. This can take place, for example, during or before a closing process of the door structure.

In all embodiments it is also possible for the sensor head to be passively retracted again by a closing process of the door structure. This can be done, for example, via a sliding-block guide.

Preferably, the sensor head performs a curved movement when the sensor head is retracted and/or extended. It is possible that the sensor head is held on a toothed rack or spindle. However, it is also possible that the sensor head is extended linearly. Any drive can be used for this purpose. In simple embodiments it is sufficient to move the sensor head between about 10 mm and 50 mm and in particular between about 15 mm and 30 mm and preferably about 20 mm.

In all embodiments, additional sensors are preferably provided. For example, at least one sensor may be provided in each case on the front doors, on or in the side mirrors. It is also possible that sensors are provided on the door surface on the driver's side and the passenger's side.

The invention enables reliable detection of collision/foreign objects or interfering objects in the range of movement of the doors, in particular on the rear doors, but also on the front doors. If an extendable sensor head of a sensor component is used, reliable object detection can be enabled even without exterior mirrors, side strips on the surface of the doors or sensors integrated into the door's outer skin. If an extendable sensor head is used, higher sensitivity and a larger detection angle of the sensor component are enabled.

A sensor component is preferably located inside the door structure. The sensor head can be passed through to the outside at feedthroughs or recesses of attachment components. Preferably, the sensor head of the sensor component is accommodated and guided closely below the outer skin of the door structure.

In such embodiments, the door can be closed even when the sensor head is situated outside the interior, in particular when the sensor head is extended into the wheel well of the motor vehicle.

In all embodiments it is preferred that the sensor component is part of a radar system and performs an antenna function.

Preferably, an active door damper is arranged on the door device, which enables controlled and active braking of a door movement of the door structure. Furthermore, it is preferred that a door drive is provided by means of which opening and/or closing the door structure is enabled.

In all embodiments, the extendable sensor component and/or the extendable sensor head thereof can be configured such that the near field outside the door is measured in the extended position. It is possible and preferred that in an intermediate position, the space between the door and the body opening (i.e. the entry area) is measured or forms the measuring area.

Then it is possible to use only one sensor, which would save costs. This is because if one enters with the door open and closes the door, the near field outside the door is not needed.

In all embodiments it is preferred that the sensor component as a whole and/or the sensor head (additionally) be moved up and down (i.e., in particular at least approximately vertically). The travel movement (extension path or extension movement) does not have to be horizontal, it can also be oblique.

It is possible that the sensor head is additionally displaceable/movable—relative to the sensor receptacle. The sensor head can also rotate (just like the radars on the ships . . . ). This can improve the detection range or the detection quality. A fixed and immovably installed sensor is not able to do that.

The door device according to the invention can be used not only on motor vehicles, but also on door devices of buildings or apartments. In this case, a door device comprises a door structure that is movable relative to a base frame, and for the purpose of environment detection, a movable sensor component is at least partially accommodated on or closely adjacent to the door structure or the base frame. In preferred embodiments, the door device can comprise previously described refinements (identical or corresponding).

Further advantages and features of the present invention will be apparent from the exemplary embodiments which are explained below with reference to the accompanying figures.

In the figures:

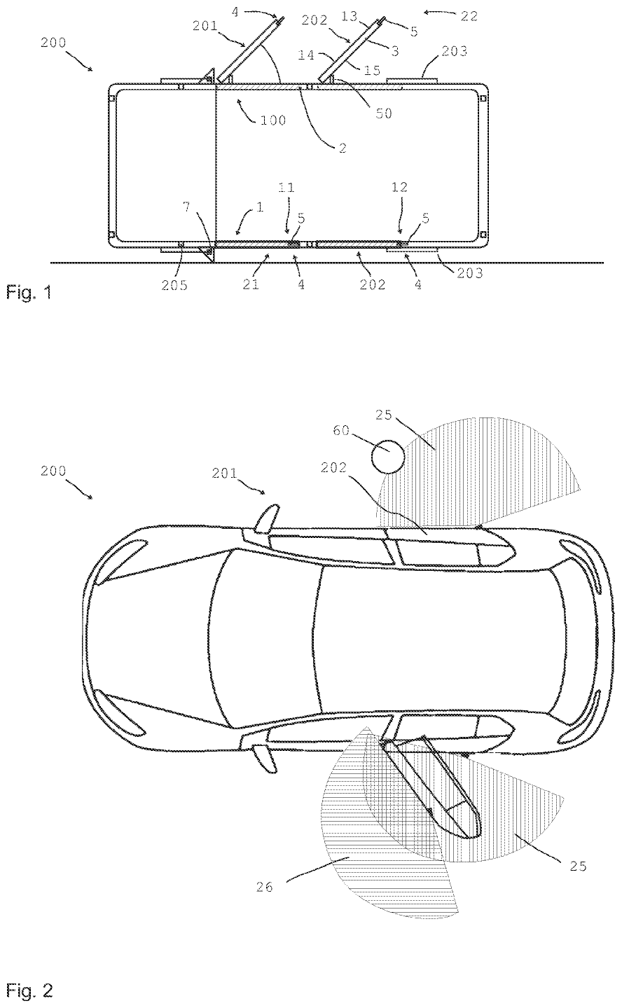

FIG. 1 shows a schematic top view of a motor vehicle equipped with door devices according to the invention;

FIG. 2 shows a top view of a motor vehicle equipped with door devices according to the invention;

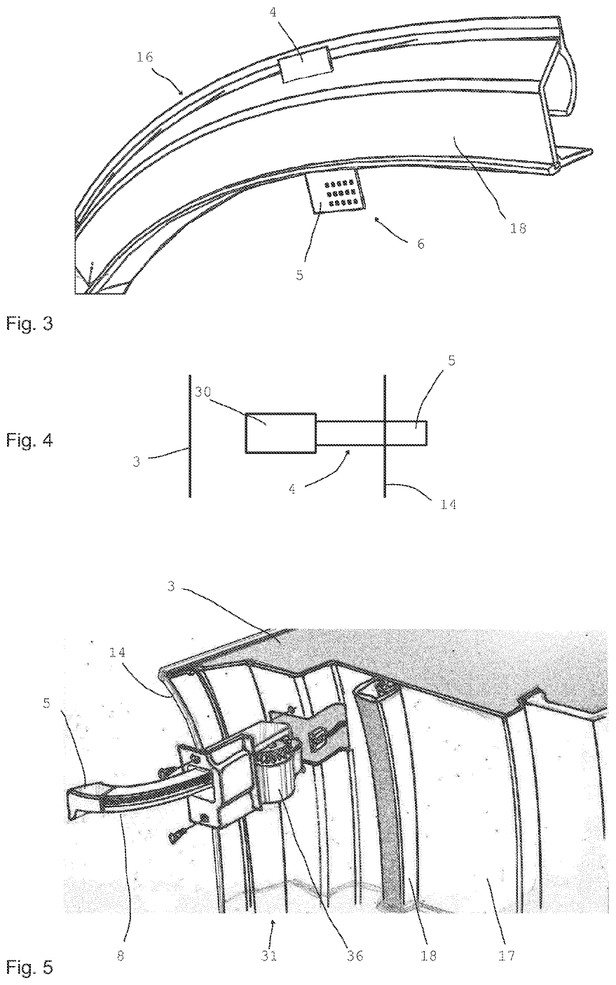

FIG. 3 shows a highly schematic view of a sensor component on an attachment part;

FIG. 4 shows a highly schematic view of the sensor component in a door device;

FIG. 5 shows a further highly schematic perspective view of a door device;

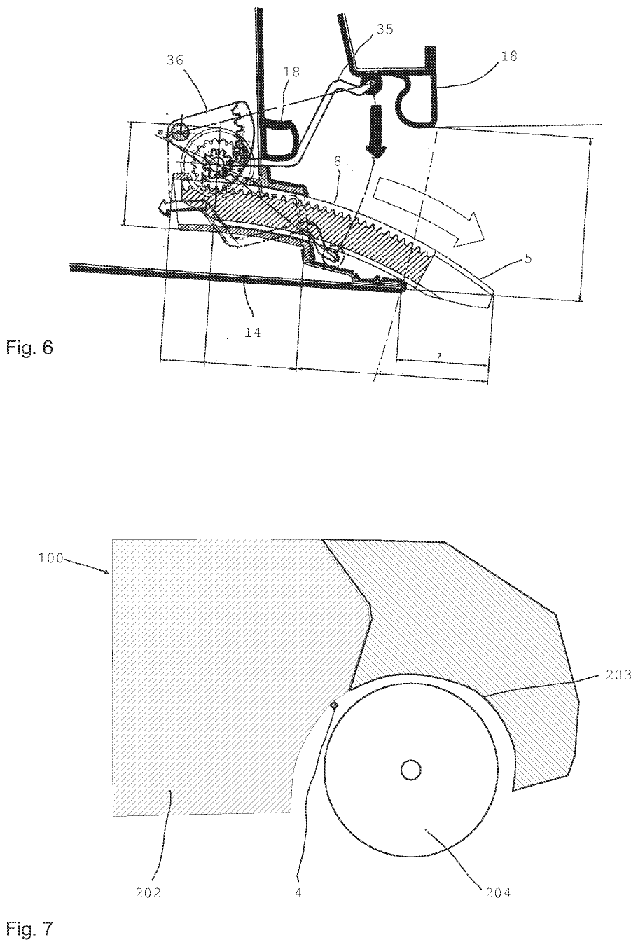

FIG. 6 shows a schematic horizontal section through a further exemplary embodiment of a door device; and

FIG. 7 shows a highly schematic side view of a motor vehicle with a door device according to the invention.

FIG. 1 shows a highly schematic top view of a motor vehicle 200, which here has four doors 1 or car door devices 100. Here, on the right-hand side of the vehicle, the front door 201 and the rear door 202 are each open, while on the left-hand side of the vehicle they are shown closed.

The motor vehicle has four wheel wells 203. The side mirrors are provided in the front regions. Sensors 7 which detect the surroundings can be arranged in the side mirrors.

At least one sensor component 4 is provided in particular on each of the rear doors 202 of the motor vehicle 200. The sensor components 4 each comprise a sensor head 5, which is shown on both rear doors 202 in the extended state in which the sensor head 5 protrudes outwardly from the door in each case.

When the door 202 is open, the sensor head 5 protrudes outwardly from the door structure 3. As a result, a particularly large and effective angular range is detected in that interfering bodies or foreign bodies 60 (compare FIG. 2) can be detected. This makes it possible that the outer skin 14 and the inner skin 15 are not damaged when the door is opened and closed. This was previously not possible with rear doors 202.

In the case of the front left door, the sensor component 4 or rather the sensor head 5 of the sensor component 4 is shown in the idle state 11 in which the sensor head 5 is situated substantially or even completely inside the interior of the door structure 3. This is the idle position 21.

The rear door 202 is shown on the left side of the motor vehicle 200 in the measurement state 12. Here, the door 202 is closed as well, but the sensor head 5 of the sensor component 4 is in the measurement state 12 and here in the extended measurement position 22. It is possible that the sensor component is fixedly mounted to the door device and there in particular to the door structure. In this case, the sensor component is not movable relative to the door structure 3. Preferably, in such cases, a measurement position 22 is assumed because the sensor head 5 is situated outside the interior of the door structure 3.

FIG. 2 shows a highly schematic top view of a motor vehicle 200 with front doors 201 and rear doors 202, wherein the detection range 25 of the sensor component 4, which results when the door is closed, is shown hatched on the right-hand side. Here, the foreign body 60, such as a pillar or the like, is reliably detected so that the opening angle can be specifically limited by means of a braking device 40.

On the left side of the motor vehicle 200 from FIG. 2, the detection ranges 25 and 26, which result when the door is closed (detection range 25) and when the door is open (detection range 26), are shown hatched.

FIG. 3 shows a highly schematic perspective view of an attachment part 16, such as a trim element 17 or a seal 18, which can be attached to a door body 13 of a door device 1. A feedthrough for the sensor component 4 is provided within the attachment part 16, so that a portion 6 and in particular the sensor head 5 extends to the outside. For example, the extension point can be formed in the area of the rear wheel well so that the sensor head 5 can remain extended when the door is open and closed.

FIG. 4 shows a schematic top view of a door device 1, with the sensor component 4 being arranged inside the door structure 3 (=car door). An actuator 30 is used here for actively moving the sensor head 5 out of the interior of the door structure 3 through the outer skin 14 to the outside. It is also possible that the sensor head 5 is guided to the outside through a recess or a feedthrough on an attachment part, as in FIG. 3.

FIG. 5 shows an alternative embodiment in which the sensor component 4 is secured to the door body 13. Here, the sensor component 4 has an electric motor 36 which, via a pinion, drives a toothed rack which is formed as a banana-shaped arm, for example, and carries the sensor head 5 at the distal end. By extending the arm 8, the sensor head 5 can be placed further out and can thus detect a wider surrounding area. Here, the electric motor is an active actuator 31, preferably with a position sensor. The sensor component can already measure the environment during the extension, which, due to the banana-shaped configuration or the resulting movement path, results in a spatial image of the environment and many more measuring points than a fixedly installed sensor head. Also, it is not mandatory that the sensor component remains in the maximum position. The measurement accuracy and measurement quality can noticeably increase if the sensor head oscillates or moves in such a manner that the collision object 60 can be detected (measured) in the best possible way. The sensor can preferably (also additionally) be moved vertically.

In the case of an active door, the sensor can also be intelligently linked here to the door actuator, i.e., if a collision object is not reliably detected, the door opening speed can slow down so that the sensor component has more time for measuring. Also, the door can change the direction of movement (oscillate slightly itself) so that the measurement quality is increased. Thus, the door itself and the sensor component can also oscillate/wobble during measurement. A plurality of measurement data can be collected and analyzed in a computer. As a result—thus depending on the situation and environment—the sensors and the door are individually and accordingly controlled and sometimes moved, which increases the measurement and detection quality.

FIG. 6 shows yet another example in a horizontal section, again comprising an extending arm 8 on which, for example, a toothed rack is formed in order to actively retract or extend the arm 8 of the sensor component 4 via the motor 36. In the extended state, the sensor head 5 projects far beyond the outer skin 14 of the door device 1.

It is also possible that the extension is implemented via a spring 35 which results in automatic extension of the sensor head 5 when the door structure 3 of the door device 1 is opened.

The sensor head's side facing the vehicle interior can accommodate a second sensor, which then detects the area between the door and the door cutout in the body (entry/exit area). This results in a cost-effective solution for finger pinch protection, for example. This sensor component, too, can already measure the environment during extension/retraction, which, due to the circular segment movement path, results in a spatial image of the environment and many more measurement points than a fixedly installed sensor head. In particular, the sensor can additionally also be moved vertically.

The retraction/extension movement of the sensor (sensor head) can also be designed in such a manner that the exterior area is measured with a sensor in the extended state and the intermediate area between the door and the car body is measured when the sensor is retracted. This can be achieved, e.g., in that the sensor head or the entire sensor unit swivels by 180° about its own axis during extension.

Finally, FIG. 7 shows a highly schematic side view of a motor vehicle 200, wherein here the rear wheel well 203 can be seen, in which a wheel 204 is arranged. The rear door 202 can be opened, wherein a sensor component 4 is attached to the rear door 202 which here extends into the wheel well 203 in the rear region of the rear door 202.

The sensor component 4 may be larger or smaller than shown here in the exemplary embodiments. Hereby it is possible to form a stationary sensor component which, for example, constantly projects outwardly from the interior of the door structure 3. It is also possible to design the sensor head 5 of the sensor component 4 to be movable, the sensor head preferably extending when the door starts to open.

If, in particular, the sensor component is configured to be static, it is preferably painted in the color of the motor vehicle and is integrated into the design of the motor vehicle so that the sensor component is little or not at all noticeable.

It is possible that the sensor component is arranged inside the door structure and is covered, for example, by an aluminum layer on the outer skin 14.

In all embodiments, a wide variety of sensors provided on a motor vehicle can be used for near-field detection.

In all embodiments, the sensor unit can be designed as or comprise at least one radar sensor. For example, the sensor unit can be designed as a so-called ultra-wideband radar sensor. In this case, the sensor unit is designed to emit at least one ultrashort pulse and to receive the corresponding reflections again and evaluate them. For example, a change in phase, frequency, wavelength and/or propagation time can be used for detection of the environment.

In a particularly advantageous embodiment, the sensor unit comprises at least one transmitting unit. The transmitting unit is preferably suitable and designed to transmit at least one signal. The receiving unit is preferably suitable and designed to receive at least one reflection of the transmitted signal emanating at least partially from the collision object and to detect it as a signal. The detection device is preferably suitable and designed to detect the impassability as a function of the detected signal. Furthermore, the detection device is in particular suitable and designed to control the passive or active door device as a function of the detected impassability so that at least one actuating or damping characteristic of the damper device can be set by a signal from the detection device. The reflected signal can be processed particularly advantageously by the detection device and can be used for a particularly reliable detection of collision/obstacle objects.

The transmitted or received signal is in particular a transverse wave and/or a longitudinal wave, for example an electromagnetic wave and/or a sound wave. It is possible that the wave is subjected to corresponding modulations. Transmission as a pulse and in particular as an ultrashort pulse is also possible. A pulse phase modulation can be provided. The differences between the transmitted and reflected signals are, for example, characteristic of the size, shape and/or material composition of the collision/interference object. The differences in the transmitted and reflected signals relate to, e.g., amplitude, frequency, wavelength, phase, and/or polarization.

Interference between a transmitted signal and a received signal can also be determined. For example, the sensor unit is designed as or can comprise an interferometer. Preferably, signals in the range of shorter wavelengths are used for this purpose, such as visible light. Preferably, the transmitting unit and the receiving unit are integrated in at least one common sensor. It is also possible that the transmitting unit and the receiving unit are designed separately. In this case, the transmission between the sensor unit and the detection device can be wireless. However, at least one corresponding connecting line can also be provided.

Further sensor principles can be: thermal image sensor, image recognition/vision sensors, video sensors, ultrasonic, photonic mixer device, radar (24 GHz, 77 GHz . . . ), lidar (light detection and ranging).

In all embodiments it is preferred that of the sensor component only the sensor head and in particular an antenna extends outwardly from the interior of the door structure. It is possible that a stroke of about 10-30 mm is sufficient to move the sensor head outwardly from the interior. In other embodiments it can also be useful or possible for the stroke to be 50, 60, 70 or 80 mm.

A sensor head made of a flexible material prevents the sensor head from breaking when it comes into contact with other objects or the user.

Preferably, the sensor component as a whole is attached to the door body of the door structure and, for example, screwed on or also glued on.

Overall, the invention provides a very simple solution. It does not interfere with the design of a motor vehicle. It can be installed on many vehicles, in particular if the sensor head is fed through a seal on a vehicle door. Many seals on doors and even the basic design of doors are relatively similar on different vehicles.

It is possible to install a plurality of sensors, if necessary. They can also be installed in the B-pillar or other areas of the vehicle.

If such a sensor system or component is not needed, a normal seal can be installed. For vehicles with an active door opening and/or an active door brake, seals can be installed through which a sensor component can be fed.

In preferred embodiments, it is possible to extend the sensor head of a sensor component even when the door is closed.

In all embodiments, the sensor component is always protected against soiling, which is very important. In the retracted state within the door structure, the sensor component is fully protected. A dirty or iced sensor unit results in incorrect measurements or even failure, which can immediately lead to collision and thus damage. The user himself cannot tell whether the sensor is measuring correctly, he relies on it. Faulty measurements are therefore very detrimental to the quality of the overall system and call into question the usefulness of the overall system. When the sensor component or the sensor head is extended, the vehicle is usually stationary and soiling is not particularly likely since the doors are also always closed quickly in bad weather. After all, the customer does not want the interior exposed by the open door to become soiled by rain, snow, splash water.

In all embodiments, the sensor component, such as the parking sensors, the near-field recognition system for autonomous driving, the surround unit for parking (image recognition, surround view, the distance sensors from dynamic driving . . . ), can be networked with other sensors. The computing unit of the door sensor unit or another computing unit records the measured values and thus the environment already during driving into a parking space, a garage or parking position. An algorithm calculates the environment around the door (artificial environment) from this data, the GPS data (vehicle position . . . ) and stored data (e.g. the private garage place of the vehicle is approached daily and continuously measured, which improves the data quality each time—deep learning can be used here). When opening/closing the door, this is then compared and verified with the dynamic measured values (3D measurement) resulting from the door swiveling. This data can be made available to the vehicle itself but also to third parties, such as the navigation map manufacturer or the adjacent vehicle in a parking space or the parking lot operator. Data from stationary cameras etc. in the parking area can also be accessed. It is also conceivable that the parking lot operator makes this data available to the parking lot user in the form of retrievable data. Also, the parking area can be marked accordingly so that the vehicle is thereby informed about the environment or recognizes it intelligently. This again increases the quality of environment recognition and collision avoidance.

The presence of the systems described above depends on the vehicle class.

If, despite all these environment detection possibilities and collision avoidance improvement possibilities, reliable opening/closing the door is not possible, the door brake or the door actuator can inform the user of this by means of haptic feedback when the door is operated. This can be a rattling, an acoustic tone, a visual signal a short blocking of the door movement or similar. This also applies if one or more sensors fail(s). The user then takes over the door movement on his/her own responsibility, since it must always be possible to open the door (safety-relevant, among other things).

In principle, such a sensor component works not only on the rear door of a motor vehicle, but also on the front door, the tailgate, engine hood or sliding doors, and can also be used on other components.

The sensor unit does not have to be connected to the door control unit in a fixed (wired) manner; wireless data exchange (radio, Bluetooth, NFC, ANT, GSM, WLAN . . . ) is also possible.

### REFERENCE LIST

1 door device
2 base frame
3 door structure
4 sensor component
5 sensor head
6 portion, end portion
7 sensor
8 arm
11 idle state
12 measurement state
13 door body
14 outer skin
15 innner skin
16 attachment part
17 trim element
18 seal
21 idle position
22 measurement position
23 horizontal detection angle
24 vertical detection angle
25 detection range
26 detection range
30 actuator
31 active actuator
32 passive actuator
33 positive control
34 sliding-block guide
35 spring unit
36 motor
40 braking device
50 door drive
60 foreign body, collision object
100 car door device
200 motor vehicle
201 front door
202 rear door
203 wheel well
204 wheel
205 sensor

1-31. (canceled)

32. A door device of a motor vehicle, the door device comprising:
a base frame;
a door structure moveably mounted relative to said base frame; and
a movable sensor component for environment detection, said movable sensor component being at least partially accommodated on or closely adjacent to said door structure or said base frame.

33. The door device according to claim 32, wherein said sensor component is mounted to be extended from a protected position into at least one detection position.

34. The door device according to claim 32, wherein said sensor component comprises a sensor head which is at least temporarily arranged outside said door structure.

35. The door device according to claim 34, wherein said sensor component comprises two opposing sensor heads arranged at least temporarily outside said door structure.

36. The door device according to claim 34, wherein in an idle state, said sensor head of said sensor component is accommodated substantially within said door structure.

37. The door device according to claim 34, wherein in a measurement state, said sensor head of said sensor component is arranged at least partially outside said door structure.

38. The door device according to claim 32, wherein said sensor head is movable between at least two positions relative to said door structure.

39. The door device according to claim 32, wherein said sensor head is movably mounted out of an interior of said door structure.

40. The door device according to claim 34, further comprising an actuator, being an active actuator and/or a passive actuator, for moving said sensor head, said actuator having a positive control with a sliding-block guide and/or a spring unit, or being a motor selected from the group consisting of electric motors, hydraulic motors, and pneumatic motors.

41. The door device according to claim 34, wherein said motor is accommodated in an interior of said door structure.

42. The door device according to claim 34, wherein at least one portion of said sensor head is flexible and/or bendable.

43. The door device according to claim 42, wherein said at least one portion of said sensor head is configured to move into a wheel well of the motor vehicle.

44. The door device according to claim 32, wherein a horizontal detection angle of said sensor component is greater than 120° and wherein a vertical detection angle of said sensor component is greater than 45°.

45. The door device according to claim 32, wherein a horizontal detection angle of said sensor component is greater than 150° and wherein a vertical detection angle of said sensor component is greater than 90°.

46. The door device according to claim 34, wherein said sensor head is configured to oscillate, to wobble, or to rotate during a measuring process.

47. The door device according to claim 34, wherein said sensor component or said sensor head includes an image recognition sensor.

48. The door device according to claim 32, further comprising a braking device configured to selectively brake a relative movement of said door structure relative to said base frame, and a door drive configured for selectively opening said door structure.

49. A method for near-field detection on a door device, wherein a door structure is movable relative to a base frame, the method comprising:
monitoring an environment of the door structure to detect foreign bodies in a range of possible door movements of the door structure; and
before or during an opening of the door structure, detecting with a movable sensor head of a sensor component at least part of the environment of the door structure.

50. The method according to claim 49, which comprises, prior to a measurement, extending the sensor head at least partially out of the door structure and retracting the sensor head following the measurement.

51. The method according to claim 49, which comprises analyzing sensor data, vehicle data, and environment data using deep learning.

52. The method according to claim 49, which comprises, following a measurement, passively retracting the sensor head by a closing process of the door structure.

53. The method according to claim 49, which comprises holding the sensor head on a toothed rack or spindle.

54. A door assembly of a motor vehicle, the door assembly comprising:
a door moveably mounted relative to a base frame of the motor vehicle; and
a movable sensor component for environment detection in a vicinity of the motor vehicle, said movable sensor component having a sensor head movably mounted between a detection position in which said sensor head is extended from said door and configured to acquire information about the environment in the vicinity of the motor vehicle and a protected position inside said door in which said sensor is protected against soiling.
